(19) United States
(12) Patent Application Publication
(10) Pub. No.: US 2013/0141439 A1
(43) Pub. Date: Jun. 6, 2013

(54) METHOD AND SYSTEM FOR GENERATING ANIMATED ART EFFECTS ON STATIC IMAGES

(71) Applicant: SAMSUNG ELECTRONICS CO., LTD., Suwon-si (KR)

(72) Inventors: Konstantin KRYZHANOVSKY, Moscow (RU); Ilia SAFONOV, Moscow (RU); Alexey VILKIN, Moscow (RU); Min-suk SONG, Suwon-si (KR); Gnana Sekhar SURNENI, Suwon-si (KR)

(73) Assignee: SAMSUNG ELECTRONICS CO., LTD., Suwon-si (KR)

(21) Appl. No.: 13/691,165

(22) Filed: Nov. 30, 2012

(30) Foreign Application Priority Data
Dec. 1, 2011 (RU) 2011148914
Jul. 2, 2012 (KR) 10-2012-0071984

(51) Int. Cl. G06T 13/80

(52) U.S. Cl. CPC G06T 13/80
USPC 345/473

(57) ABSTRACT

A method and system for generating animated art effects while viewing static images, where the appearance of effects depends upon on the content of an image and parameters of accompanying sound is provided. The method of generating animated art effects on static images, based on the static image and accompanying sound feature analysis, includes storing an original static image; detecting areas of interest on the original static image and computing features of the areas of interest; creating visual objects of art effects according to the features detected in the areas of interest; detecting features of an accompanying sound; modifying parameters of visual objects in accordance with the features of the accompanying sound; and generating a frame of an animation including the original static image with superimposed visual objects of art effects.

### CROSS-REFERENCE TO RELATED PATENT APPLICATION

This application claims priority from Korean Patent Application No. 10-2012-0071984, field on Jul. 2, 2012, in the Korean Intellectual Property Office, and Russian Patent Application No. 2011148914, filed on Dec. 1, 2011, in the Russian Intellectual Property Office, the disclosures of which are incorporated herein by reference, in their entirety.

### BACKGROUND

1. Field

Methods and systems consistent with exemplary embodiments relate to image processing, and more particularly, to generation of animated art effects while viewing static images, wherein the appearance of effects depends on the content of an image and parameters of accompanying sound.

2. Description of the Related Art

Various approaches to solving the problems connected with the generation of art effects for static images are known. One approach is widespread programs for the generation of art effects for static images and/or video sequences. See for example, Adobe Photoshop®, Adobe Premier®, and Ulead Video Studio® (see http://ru.wikipedia.org/wiki/Adobe_Systems). Customarily, a user manually selects a desirable effect and customizes its parameters.

Another approach is based on analysis of the content of an image. For example, U.S. Pat. No. 7,933,454 discloses a system for improving the quality of images, based on preliminary classification. Image content is analyzed, and based on a result of the analysis, classification of the images is performed using one of a plurality of predetermined classes. Further, the image enhancement method is selected based upon the results of the classification.

A number of patents and published applications disclose methods of generating art effects. For example, U.S. Patent Application Publication No. 2009-154762 discloses a method and system for conversion of a static image with the addition of various art effects, such as a figure having oil colors, a pencil drawing, a water color figure, etc.

U.S. Pat. No. 7,593,023 discloses a method and device for the generation of art effects, wherein a number of parameters of effects are randomly installed in order to generate a unique total image with art effects or picturesque elements, such as color and depth of frame.

U.S. Pat. No. 7,904,798 provides a method and system of multimedia presentation or slide-show in which the speed of changing slides depends on the characteristics of a sound accompanying a background.

### SUMMARY

One or more exemplary embodiments provide a method of generating animated art effects for static images.

One or more exemplary embodiments also provide a system for generating animated art effects for static images.

According to an aspect of an exemplary embodiment, there is provided a method of generating animated art effects on static images, based on a static image and an accompanying sound feature analysis, the method including: registering an original static image; detecting areas of interest on the original static image and computing features of the areas of interest; creating visual objects of art effects according to the features detected in the areas of interest; detecting features of an accompanying sound; modifying parameters of visual objects in accordance with the features of the accompanying sound; and generating an animation frame including the original static image with superimposed visual objects of art effects.

In the detecting of areas of interest, a preliminary processing of the original static image may be performed on the areas of interest of the image, including at least one operation from the following list: brightness control, contrast control, gamma correction, customization of balance of white color and conversion of color system of the image.

Any subset from a set of features that includes volume, spectrum, speed, clock cycle, rate, and rhythm may be computed for the accompanying sound.

Pixels of the original static image may be processed by a filter, in the generation of the animation frame, before combining with the visual objects.

The visual objects may be randomly chosen for representation from a set of available visual objects in the generation of the animation frame.

The visual objects may be chosen for representation from a set of available visual objects based on a probability, which depends on features of the visual objects in the generation of the animation frame.

According to an aspect of another exemplary embodiment, there is provided a system for generating animated art effects on static images, the system including: a module which detects areas of interest, which are executed with the capability of performing the analysis of data of an image and detecting a position of the areas of interest; a module which detects features of the areas of interest, which are executed with the capability of computing the features of the areas of interest; a module which generates visual objects, which are executed with the capability of generating the visual objects representing an effect; a module which detects features of an accompanying sound, which is executed with the capability of computing parameters of the accompanying sound; a module which generates animation frames, which is executed with the capability of generating animation frames that have an effect, combining the static images and the visual objects, which are modified based on current features of the accompanying sound according to the semantics of operation of an effect; and a display unit which is executed with the capability of representing, to the user, the animation frames, which are received from the module which generates the animation frames.

The static images may arrive at the input of the module which detects the areas of interest, the module which detects the areas of interest may automatically detect the position of the areas of interest according to the semantics of operation of an effect, using methods and tools which process and segment images, and the list of the detected areas of interest, which is further transferred to the module which detects the features of the areas of interest, may be formed on an output of the module which detects the areas of interest.

The list of the areas of interest, which has been detected by the module which detects the areas of interest, and the static images may arrive as an input of the module which detects the features of the areas of interest; the module which detects the features of the areas of interest may compute a set of features according to the semantics of operation of an effect for each area of interest from the input list, and the list of the features of the areas of interest, which is further transferred to the module which generates the visual objects, may be formed on an output of the module which detects the features of the areas of interest.

The list of the features of the areas of interest may arrive as an input of the module which generates the visual objects, the module which generates the visual objects may generate a set of visual objects, such as figures, trajectories, sets of peaks, textures, styles, and also composite objects according to the semantics of operation of an effect, and the list of visual objects, which is further transferred to the module which generates the animation frames, may be formed at an output of the module which generates the visual objects.

The fragment of an audio signal of accompanying sound may arrive as an input of the module which detects the features of the accompanying sound, the module which detects the features of the accompanying sound may analyze audio data and may detect features according to the semantics of the operation of an effect, and the list of features of accompanying sound for a current moment of time may be formed on an output of the module which detects the features of the accompanying sound by requests of the module which generates the animation frames.

The static images, the list of visual objects of an effect, and the list of features of accompanying sound may arrive as an input of the module which generates the animation frames, the module which generates the animation frames may form the image of a frame of the animation, consisting of the static images with the superimposed visual objects which parameters are modified based on accompanying sound features according to semantics of an effect, and the image of the animation frame, which is further transferred to the display unit, may be formed at an output of the module which generates the animation frames.

The module which detects the features of the accompanying sound may contain the block of extrapolation of values of features that allows the module which detects the features of the accompanying sound to work asynchronously with the module which generates the animation frames.

The module which detects the features of the accompanying sound may process new fragments of audio data as the new fragments of audio data become accessible, and may provide accompanying sound features in reply to requests of the module which generates the animation frames; selectively performing extrapolation of values of features.

The module which detects the features of accompanying sound may contain the block of interpolation of values of features that allows the module which detects the features of accompanying sound to work asynchronously with the module which generates the animation frames.

The module which detects the features of accompanying sound may process new fragments of audio data as the new fragments of audio data become accessible, and may provide accompanying sound features in response to requests of the module which generates the animation frames, selectively performing interpolation of values of features.

According to an aspect of another exemplary embodiment, there is provided a computer-readable recording medium having embodied thereon a program for executing the method of generating animated art effects on static images.

### BRIEF DESCRIPTION OF THE DRAWINGS

The above and other aspects will become more apparent by describing in detail exemplary embodiments with reference to the attached drawings in which:

FIG. 1 illustrates an example of animation frames including a “Flashing light” effect;

FIG. 2 is a flowchart illustrating a method of generating and displaying animated art effects on static images, based on a static image and accompanying sound feature analysis, according to an exemplary embodiment;

FIG. 3 illustrates a system which generates animated art effects on static images, according an exemplary embodiment;

FIG. 4 is a flowchart illustrating a procedure of detecting areas of interest for an effect of “Flashing light;”

FIG. 5 is a flowchart illustrating a procedure of detecting of parameters of a background accompanying sound for an effect of “Flashing light;”

FIG. 6 is a flowchart illustrating a procedure of generating animation frames for an effect of “Flashing light;” and

FIG. 7 is a flowchart illustrating a procedure of generating animation frames for an effect of “Sunlight spot.”

### DETAILED DESCRIPTION OF THE EXEMPLARY EMBODIMENTS

Exemplary embodiments will now be described more fully with reference to the accompanying drawings.

The terms used in this disclosure are selected from among common terms that are currently widely used in consideration of their function in the inventive concept. However, the terms may be changed according to the intention of one of ordinary skill in the art, a precedent, or due to the advent of new technology. Also, in particular cases, the terms are discretionally selected by the applicant, and the meaning of the terms will be described in detail in the corresponding portion of the detailed description. Therefore, the terms used in this disclosure are not merely designations of the terms, but the terms are defined based on the meaning of the terms and content throughout the inventive concept.

Throughout the application, when a part “includes” an element, it is to be understood that the part additionally includes other elements rather than excluding other elements as long as there is no particular alternate or opposing recitation. Also, the terms such as “ . . . unit,” “module,” and the like used in the disclosure indicate an unit, which processes at least one function or motion, and the unit may be implemented by hardware or software, or by a combination of hardware and software.

Exemplary embodiments will now be described more fully with reference to the accompanying drawings for one of ordinary skill in the art to be able to carry out the inventive concept without any difficulty. The inventive concept may, however, be embodied in many different forms and should not be construed as being limited to the embodiments set forth herein. Rather, these embodiments are provided so that this disclosure will be thorough and complete, and will fully convey the concept of the invention to those of ordinary skill in the art. Also, parts in the drawings unrelated to the detailed description are omitted for purposes of clarity in describing the exemplary embodiments. Like reference numerals in the drawings denote like elements.

The main drawback of known tools used for the generation of dynamic/animated art effects for static images is that they allow effects to be added and to only manually customize its parameters, which requires certain knowledge by the user, and takes a long time. The animation, which is received as a result, is saved in a file as a frame or video sequence and occupies a lot of memory. While playing, the same frames of a video sequence are repeated in a manner that quickly tires the spectator. The absence of known methods is observed, which allow dynamically changing the appearance of animation effects depending on features (parameters) of an image and parameters of a background accompanying sound.

The exemplary embodiments are directed to the development of tools providing automatic, i.e. without involvement of the user, generation of animated art effects for a static image with improved aesthetic characteristics. In particular, the improved aesthetic appearance is due to adapting parameters of effects for each image and changing parameters of effects depending on the parameters of the accompanying sound. This approach practically provides practically a total absence of repetitions of generated frames of animation in time and effect of change of frames, according to a background accompanying sound.

It should be noted that many modern electronic devices possess multimedia capabilities and provide static images, such as photos, in the form of slide shows. Such slide shows are often accompanied by a background accompanying sound in the form of music. Various animated art effects, which draw the attention of the user, can be applied to the showing of static images. Such effects are normally connected to the movement of certain visual objects in the image or local change of fragments of the image. In the inventive concept, the number of initial parameters of visual objects depends on the content of the image and, accordingly, the appearance of animation varies between images. The number of parameters of effects depends on the parameters of a background accompanying sound. These parameters include, volume, allocation of frequencies in a sound spectrum, rhythm, rate, and the appearance of visual objects varies between frames.

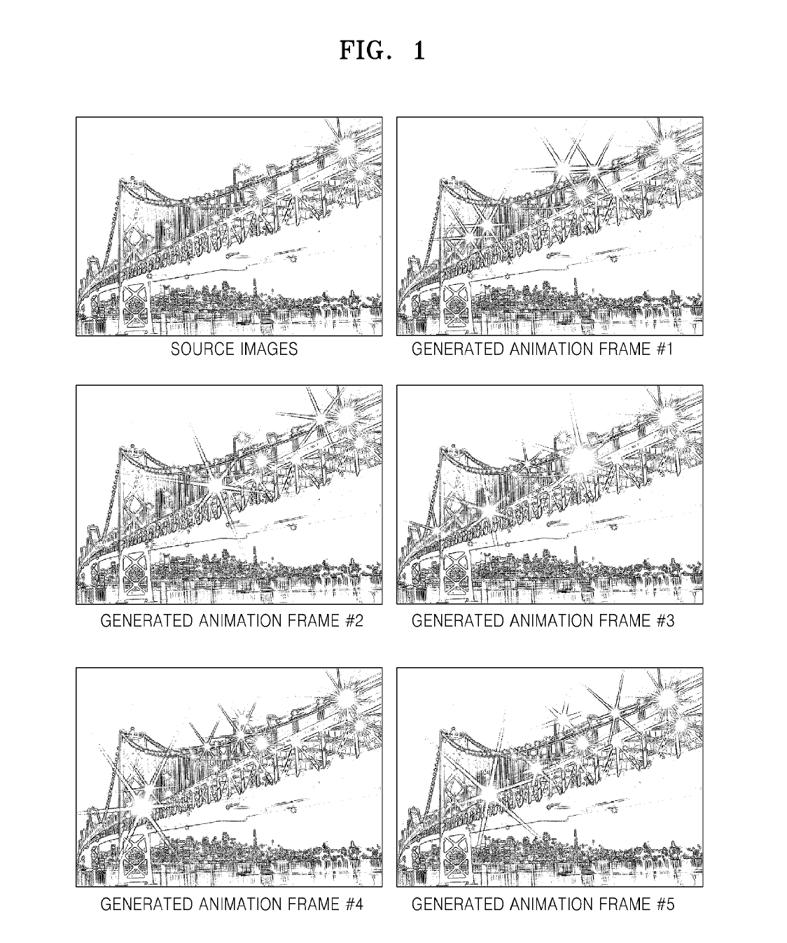

FIG. 1 shows, as an example, several animation frames with “flashing light” effects, performed according to an exemplary embodiment of the inventive concept. In the given effect, the positions, the dimensions, and color of flashing stars depend on the positions, the dimensions, and color of the brightest locations of the original static image. The frequency of flashing of stars depends on the parameters of a background accompanying sound, such as a spectrum (allocation of frequencies), rate, rhythm, and volume.

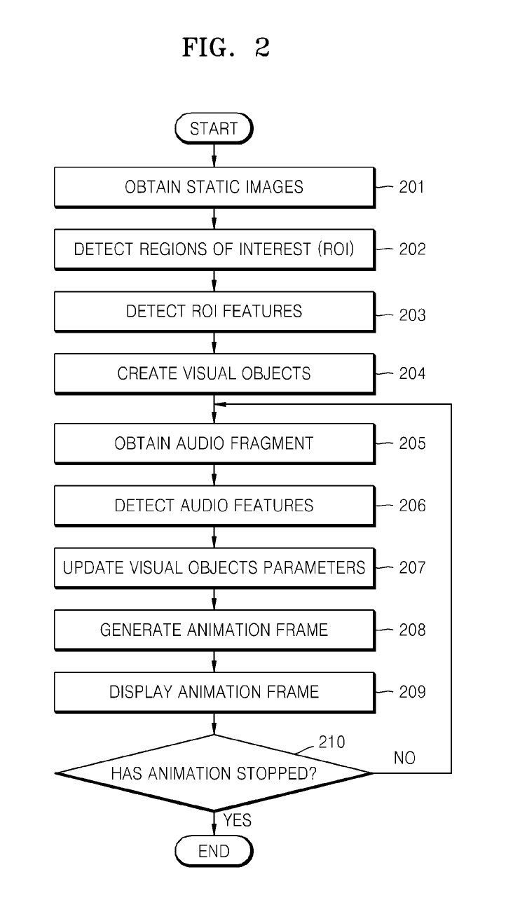

FIG. 2 is a flowchart illustrating a method of generating and displaying animated art effects on static images, based on a static image and accompanying sound feature analysis, according to an exemplary embodiment. In operation 201, the original static image is stored/input. Further, depending on the semantics of effects, areas of interest, i.e., regions of interest (ROI), are detected on the image (operation 202) and their features (operation 203) are computed. In operation 204, visual objects of art effects are generated according to features detected before areas of interest. The following operations are repeated for the generation of each subsequent animation frame:

receive accompanying sound fragment (operation 205) and detect accompanying sound features (operation 206);

modify parameters of visual objects according to the accompanying sound features (operation 207);

generate the animation frame including the initial static image with superimposed visual objects of art effects (operation 208);

visualize an animation frame on a display (operation 209).

The enumerated operations are performed until a time expires or until an end command to end an effect is provided by a user (operation 210).

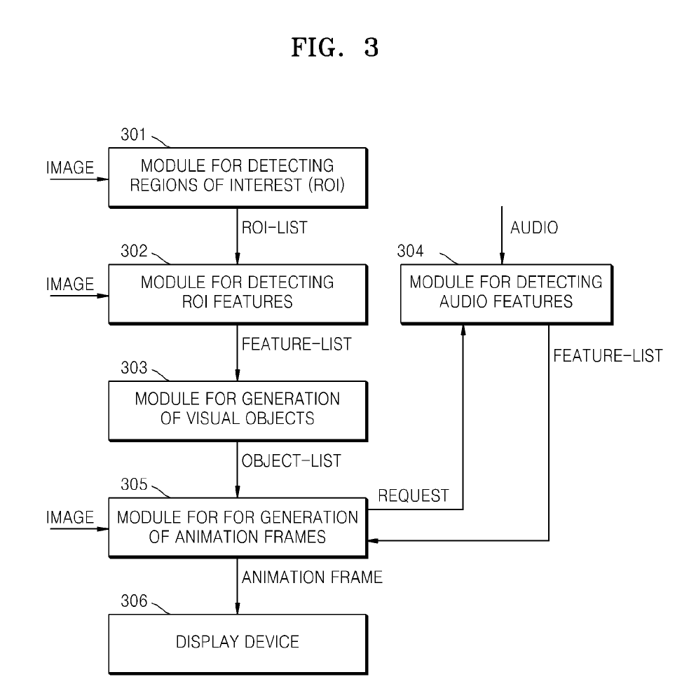

FIG. 3 illustrates a system for generating animated art effects on static images, according an exemplary embodiment. A module 301 which detects areas of interest receives the original static image. The module 301 is executed to perform the preprocessing operations on the original static image, such as brightness control and contrast, gamma correction, color balance control, conversion between color systems, etc. The module 301 automatically detects the positions of areas of interest according to the semantics of operation of an effect, using methods of segmenting images and morphological filtering. Various methods of segmenting and parametrical filtering based on brightness, color, textural and morphological features can be used. A list of the detected areas of interest is formed as an output of the module, which is further transferred to the module 302 for detecting features of areas of interest.

The module 302 which detects features of areas of interest receives the initial static image and the list of areas of interest as an input. For each area of interest, the module 302 computes a set of features according to the semantics of art effects. Brightness, color, textural and morphological features of areas of interest are used. The list of features of areas of interest is further transferred to a module 303 for generation of visual objects.

The module 303 which generates visual objects generates a set of visual objects, such as figures, trajectories, sets of peaks, textures, styles, and also composite objects, according to the semantics of operation of an effect and the features of areas of interest. The list of visual objects or object-list, which is then transferred to a module 305 which generates animation frames, is formed as an output of the module 303.

The module 304 which detects features of accompanying sound receives a fragment of an audio signal of an accompanying sound as an input and, according to the semantics of an effect, computes accompanying sound parameters, such as volume, the spectrum of allocation of frequencies, clock cycle, rate, rhythm, etc. The module 304 is configured to function both in synchronous and asynchronous mode. In a synchronous mode, the module 304 requests a fragment of accompanying sound and computes its features for each animation frame. In an asynchronous mode, the module 304 processes accompanying sound fragments when the sound segments arrive in a system, and remembers data necessary for the computation of features of accompanying sound, at each moment of time. The module 304 which detects features of accompanying sound contains the block of extrapolation or interpolation of values of features that allows the module to work asynchronously with the module 305 which generates animation frames, i.e., the module 304 which detects features of accompanying sound processes new fragments of the audio data as they become accessible, and provides accompanying sound features in response to requests of the module 305 which generates animation frames, if necessary, to perform extrapolation or interpolation of values of features. At an output of the module 304 which detects features of accompanying sound, the list of features of accompanying sound for a current moment of time is formed by requests of the module 305 which generates animation frames.

The module 305 which generates animated frames receives as in input the original static image, visual objects, and accompanying sound parameters. The module 305 forms animation frames that have an effect, combining the original static image and the visual objects which are modified based on current features of accompanying sound, according to the semantics of operation of an effect. The image of an animation frame, which is further transferred to a device 306 for representing as a display, is formed at the output of module 305.

The device 306 which represents animation frames to the user, which are received from the module 305 which generates animated frames.

All enumerated modules can be executed in the form of systems on a chip (SoC), field programmable gate array-programmed logic arrays (FPGA-PLA), or in the form of a specialized integrated circuit (ASIC). The functions of modules are clear from their description and the description of an appropriate method, in particular, on an example of implementation of an animation art effect of “Flashing light.” The given effect shows flashing and rotation of the white or color stars allocated in small by square bright fragments of the image.

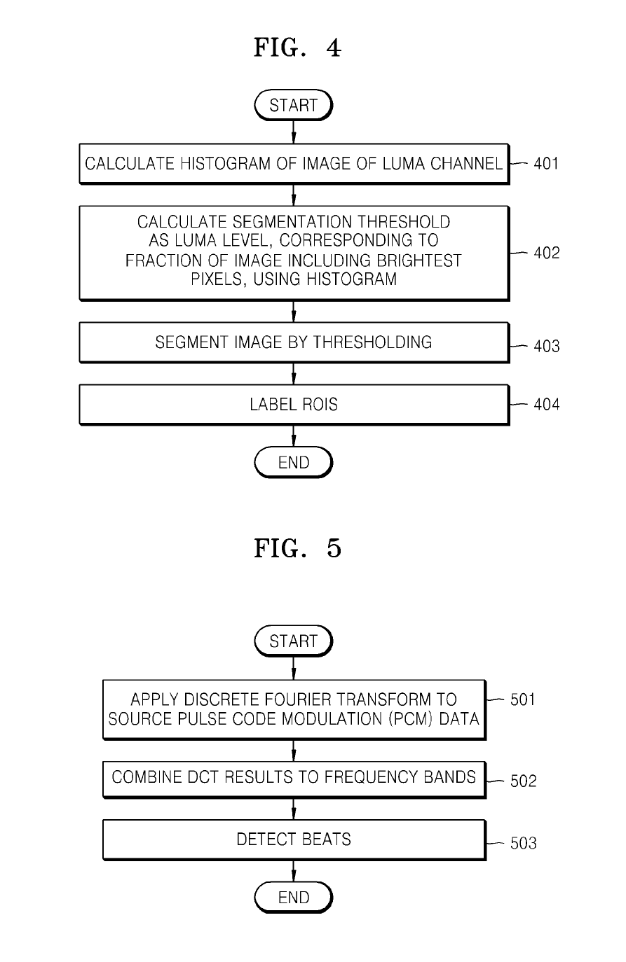

The module for detecting areas of interest performs the following operations to detect bright areas on the image (see FIG. 4):

1. Compute histograms of brightness of the original image (operation 401).

2. Compute a threshold for segmentation by using the histogram (operation 402).

3. Segment the image by threshold clipping (operation 403).

The module for detecting features of areas of interest performs the following operations:

1. For each area of interest the module for detecting features of areas of interest computes a set of features which includes, at least, the following features:

a. Average values of color components within an area.

b. Coordinates of a center of mass.

c. Ratio of the square of the area of interest to the square of the image.

d. Rotundity coefficient—the ratio of diameter of a circle with a square of the diameter to the square of an area of interest to the greatest of the linear dimensions of an area of interest.

e. Metric of similarity on a small light source, i.e., the integral parameter computed as a weighed sum of maximum brightness of an area of interest, average brightness, coefficient of rotundity and a relative square of an area of interest.

2. Selects those areas of interest from all areas of interest, which have features that satisfy a preliminary set of criteria.

The module which generates visual objects generates the list of visual objects, i.e., flashing and rotating stars, detecting the position, the dimensions, and color of each star according to the features of the areas of interest.

The module which detects the features of accompanying sound receives a fragment of accompanying sound and detects jump changes of a sound. Operations of detecting such jump changes are shown in FIG. 5. In operation 501, a fast Fourier transform (FFT) is executed for a fragment of the audio data and the spectrum of frequencies of accompanying sound is obtained. The spectrum is divided into several frequency bands. A jump change is detected, when in, at least, one of the frequency bands, a sharp change occurs over a rather small period of time (operation 503).

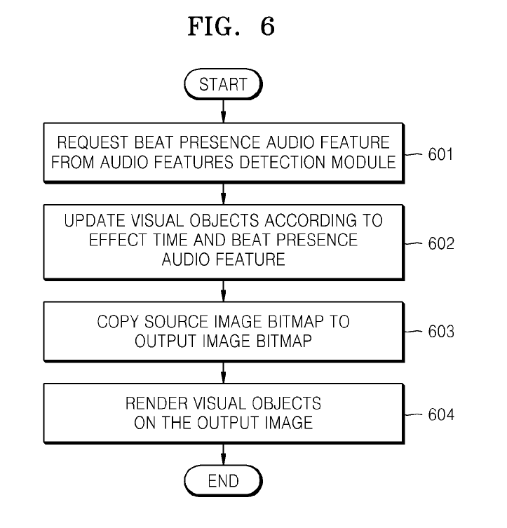

The module which generates animated frames performs the following operations for each frame (see FIG. 6):

1. Generates a request based on parameters of accompanying sound and transfers the request to the module which detects the features of accompanying sound (operation 601);

2. Modifies an appearance of visual objects, i.e., asterisks according to a current condition and accompanying sound parameters (operation 602);

3. Copies original images in the buffer of a generated frame (operation 603);

4. Executes rendering of visual objects, i.e., asterisks on a generated frame (operation 604).

As a result of an operation of a module on an animated sequence of frames, the asterisks flash in time with the accompanying sound.

Another example of the inventive concept is an animated art effect “Sunlight spot.” Light stain moves by the image in the given effect. The trajectory of movement of a stain depends on zones of attention according to a pre-attentive visual model. The speed of motion of a stain depends on a rate of the accompanying sound. The form, color, and texture of a stain depend on a spectrum of a fragment of the accompanying sound.

The module which detects areas of interest on an original image generates a map of importance or saliency, selects areas, draws attention, etc., as areas of interest. The method of fast construction of a map of saliency is described in the article “Efficient Construction of Saliency Map,” by Wen-Fu Lee, Tai-Hsiang Huang, Yi-Hsin Huang, Mei-Lan Chu, and Horner H. Chen (SPIE-IS&T/Vol. 7240, 2009). The module which detects features of areas of interest computes the coordinates of a center of mass for each area. The module which detects of visual objects generates nodes of moving of light stain between areas of interest. The module for detecting features of accompanying sound computes a spectrum of a fragment of accompanying sound and detects a rate of accompanying sound. The approach described in article “Evaluation of Audio Beat Tracking and Music Tempo Extraction Algorithms,” by Martin F. Mckinney, D. Moelants, Matthew E. P. Davies and A. Klapuriby, (Journal of New Music Research, 2007) is used for this purpose.

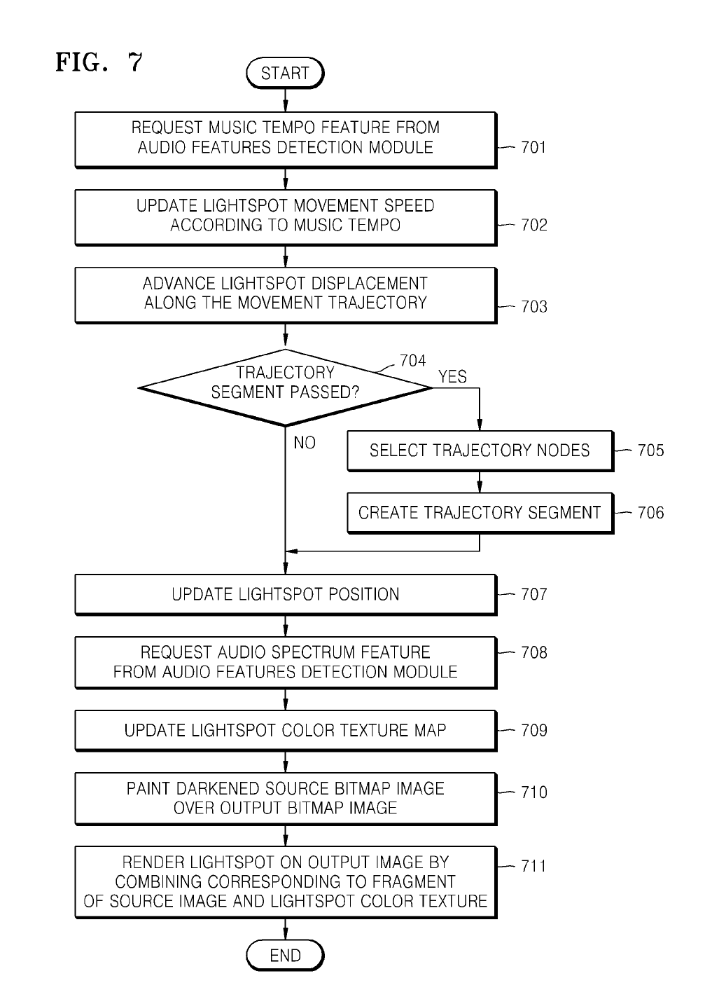

The module which generates animated frames performs the following operations (see FIG. 7):

1. Requests a rate of a fragment of accompanying sound of the module which detects features of accompanying sound (operation 701).

2. Modifies a speed of movement of a light stain according to the rate of the music tempo (operation 702).

3. Computes movements of a light stain along a fragment of trajectory (operation 703).

4. If the fragment of trajectory is passed (operation 704), the module computes looks for a new fragment of trajectory (operation 705), and then a fragment of trajectory itself (operation 706). The straight line segment, splines, or Bezier curves can be used as fragments of trajectory.

5. Modifies a position of a light stain along a current fragment of trajectory according to moving, which was computed in operation 703.

6. Requests a spectrum of a sound from the module which detects features of accompanying sound (operation 708).

7. Modifies the form, color, and texture of light stain depending on an accompanying sound spectrum (operation 709).

8. Copies the blackout of the original image in the buffer of a generated frame (operation 710).

9. Executes a rendering of a light stain on a generated animation frame (operation 711).

The contents of the above-described method may be applied to the system according to the exemplary embodiment. Accordingly, with respect to the system, the same descriptions as those of the method are not repeated.

In addition, the above-described exemplary embodiments may be implemented as an executable program that may be executed by a general-purpose digital computer or processor that runs the program by using a computer-readable recording medium. When the program is executed, the program becomes a special purpose computer.

Further aspects of the exemplary embodiments will be clear from consideration of the drawings and the description of preferable modifications. It is clear for one of ordinary skill in the art that various modifications, supplements and replacements are possible, in so far as they do not go beyond the scope and meaning of the inventive concept, which is described in the enclosed claims. For example, the whole description is constructed as an example of a slide show of the static images accompanied by a background of accompanying sound/music. However playing of music by a multimedia player can also be accompanied by a background display of a photo or a slide show of photos. The animated art effect according to the inventive concept can be applied to the background photos shown by a multimedia player.

The claimed method can find an application in any device with multimedia capabilities, in particular, the organization of a review of photos in the form of a slide show in modern digital TVs, mobile phones, tablets, photo frames, and also in the software of personal computers.

While exemplary embodiments have been particularly shown and described, it will be understood by those of ordinary skill in the art that various changes in form and details may be made therein without departing from the spirit and scope of the inventive concept as defined by the following claims.

What is claimed is:

1. A method of generating animated art effects on static images, the method comprising:
detecting areas of interest on an original static image and determining features of the areas of interest;
creating visual objects of art effects which relate to the features of the areas of interest;
modifying parameters of visual objects in accordance with features of an accompanying sound; and
generating an animation frame comprising the original static image with superimposed visual objects of art effects.

2. The method of claim 1, wherein the detecting of areas of interest comprises processing the original static image by performing at least one of brightness control, contrast control, gamma correction, customization of balance of white color and conversion of the color system of the original static image.

3. The method of claim 1, wherein the features of the accompanying sound the accompanying sound comprise volume, spectrum, speed, clock cycle, rate and rhythm.

4. The method of claim 1, wherein the generating of the animation frame comprises processing pixels of the original static image by a filter, before combining the processed pixels with the visual objects.

5. The method of claim 1, wherein in the generating of the animation frame, the visual objects are randomly chosen for representation from a set of available visual objects.

6. The method of claim 1, wherein in the generating of the animation frame the visual objects are chosen for representation from a set of available visual objects based on a probability, which depends on features of the visual objects.

7. A system for generating animated art effects on static images, the system comprising:
a module which detects areas of interest on an original static image and which detects a position of the areas of interest;
a module which detects features of the areas of interest;
a module which generates visual objects of art effects which relate to the features of the areas of interest;
a module which detects features of an accompanying sound and determines parameters of the accompanying sound;
a module which generates animation frames by combining the static images and the visual objects, which are modified based on current features of the accompanying sound, according to semantics of operation of an effect; and
a display unit which displays the animation frames.

8. The system of claim 7, wherein the module which detects the areas of interest automatically detects the position of the areas of interest according to semantics of operation of an effect, using methods and tools of processing and segmentation of images, and a list of the detected areas of interest, is formed at an output of the module which detects the areas of interest.

9. The system of claim 8, wherein the list of the areas of interest and the static images are provided as an input of the module which detects the features of the areas of interest; the module which detects the features of the areas of interest computes a set of features according to the semantics of operation of an effect for each area of interest from the input list, and the list of the features of the areas of interest, which is further transferred to the module which generates the visual objects, is formed at an output of the module which detects the features of the areas of interest.

10. The system of claim 9, wherein the list of the features of the areas of interest are provided as an input of the module which generates the visual objects, the module which generates the visual objects generates a set of visual objects from a group including figures, trajectories, sets of peaks, textures, styles, and composite objects, according to the semantics of operation of the effect, and wherein the list of visual objects is formed at an output of the module which generates the visual objects.

11. The system of claim 10, wherein a fragment of an audio signal of accompanying sound arrives as an input of the module which detects the features of the accompanying sound, the module which detects the features of the accompanying sound analyzes audio data and detects features according to the semantics of operation of the effect, and the list of features of accompanying sound for a current moment of time is formed at an output of the module which detects the features of the accompanying sound by request of the module which generates the animation frames.

12. The system of claim 11, wherein the static images, the list of visual objects of an effect, and the list of features of accompanying sound are provided as an input to the module which generates the animation frames, and wherein the image of the animation frame, which is transferred to the display unit, is formed at an output of the module which generates the animation frames.

13. The system of claim 7, wherein the module which detects the features of the accompanying sound contains a block of extrapolation of values of features that allows the module which detects the features of the accompanying sound to work asynchronously with the module which generates the animation frames.

14. The system of claim 13, wherein the module which detects the features of the accompanying sound, processes new fragments of audio data as the new fragments of audio data become accessible, and provides accompanying sound features in reply to requests of the module which generates the animation frames, selectively performing extrapolation of values of features.

15. The system of claim 7, wherein the module which detects the features of the accompanying sound contains a block of interpolation of values of features that allows the module which detects the features of accompanying sound to work asynchronously with the module which generates the animation frames.

16. The system of claim 15, wherein the module which detects the features of the accompanying sound, processes new fragments of audio data as the new fragments of audio data become accessible, and wherein the module provides accompanying sound features in response to requests of the module which generates the animation frames, selectively performing interpolation of values of features.

17. A non-transitory computer-readable recording medium having embodied thereon a program, wherein the program, when executed by a processor of a computer, causes the computer to execute the method of claim 1.

18. A system for generating animated art effects on static images, the system comprising:
a module which detects areas of interest of a static image, as well as positions of the areas of interest and features of the areas of interest;
a module which generates visual objects of an effect;
a module which detects features and parameters of an accompanying sound;
a module which generates animation frames by combining static images, the parameters of the accompanying sound and the visual objects, which are modified according to semantics of operation of an effect.

19. The system of claim 18, wherein the module which detects the position and features of the areas of interest, processes and segments images, and wherein the detected areas of interest are provided at an output of the module which detects the areas of interest.

20. The system of claim 19, wherein a list of the features of the areas of interest is transferred to the module which generates the visual objects.

21. The system of claim 18, wherein the module which detects the features of the accompanying sound contains a block of extrapolation of values of features that allows the module which detects the features of the accompanying sound to work asynchronously with the module which generates the animation frames.

22. The system of claim 21, wherein the module which detects the features of the accompanying sound, processes new fragments of audio data as they become available, and provides accompanying sound features in reply to requests from the module which generates the animation frames.

23. A method of generating animated art effects on static images, the method comprising:
detecting areas of interest and computing features relating to the areas of interest in an original static image;
generating visual objects of art effects which relate to the detected features;
modifying parameters of visual objects in accordance with features of an accompanying sound; and
generating an animation frame comprising the original static image with superimposed visual objects of art effects.

24. The method of claim 23, wherein the detecting of the areas of interest comprises performing at least one of brightness control, contrast control, gamma correction, customization of balance of white color and conversion of the color system of the image.

25. The method of claim 23, wherein the accompanying sound is determined by at least one of volume, spectrum, speed, clock cycle, rate and rhythm.
